(19) United States
(12) Patent Application Publication
(10) Pub. No.: US 2006/0273652 A1
(43) Pub. Date: Dec. 7, 2006

(54) Balance weight

(75) Inventors: Larry D. Winch, Crestline, OH (US); Mark P. Fowler, Mansfield, OH (US)

Correspondence Address: James E. Scarbrough, Esq.;Fay, Sharpe, Fagan, Minnich & McKee, LLP, 7th Floor, 1100 Superior Avenue, Cleveland, OH, 44114-2518, US

(73) Assignee: Conceptual Plastic Creations, LLC

(21) Appl. No.: 11/430,695

(22) Filed: May 9, 2006

Related U.S. Application Data
(60) Provisional application No. 60/679,824, filed on May 11, 2005.
(60) Provisional application No. 60/763,288, filed on Jan. 30, 2006.

(51) Int. Cl. B60B 1/00

(52) U.S. Cl. 301/5.21

(57) ABSTRACT

A balance weight has a body having a cavity formed therein, a solid weight member substantially filling the cavity of the body; and an adhesive formed on a side of the body for securing the balance weight to an associated object to be balanced. A balance weight can be secured to a tire and weight assembly and has a solid body formed entirely of plastic material, wherein the body is secured to the tire and wheel assembly via an adhesive layer on one side of the body. The body can have an internal cavity formed within the body and a weight member made of metal which substantially fills the internal cavity.

### CLAIM OF PRIORITY

This application claims priority from provisional application Ser. Nos. 60/679,824 filed on May 11, 2005 and 60/763,288 filed on Jan. 30, 2006.

### BACKGROUND

This invention relates to balance weights. In particular, the invention relates to a balance weight which is used with a wheel of a motor vehicle, such as a truck or automobile, although the weight can be used in other applications as well.

Proper rotational balance of an automobile's tires is essential in order to provide a smooth ride, optimize handling characteristics, minimize wear and tear to the vehicle and extend the service life of the tires. A tire is normally balanced after its mounting to a wheel by the attachment of weight to the wheel. The balancing procedure typically includes the steps of spinning the wheel and tire assembly up to speed, measuring the forces generated by any imbalances, determining the amount of weight and the precise placement of such weight necessary to counteract the measured forces and clipping or adhering weights to the wheel. In order to achieve dynamic balance it is usually necessary for balancing weights to be attached to both the inboard as well as outboard edges of the wheel. Clip-on weights are attached directly to the wheel flanges while adhesive weights are usually attached to the curb side and brake side of the wheel immediately adjacent to the wheel's flanges. If the wheel is sufficiently offset, the weight required on the outboard edge of the wheel can sometimes be hidden by attaching it to the wheel just inboard of the wheel's center element. The assembly is then again spun up to speed to confirm that proper balance has been achieved. Occasionally, the entire balancing procedure must be repeated if a further readjustment is found to be necessary.

The source of an imbalance in a tire and wheel combination is often a combination of imbalances inherent in the tire as well as the wheel. With the trend toward the use of larger and larger wheels and tires for automotive applications, more and more balancing weight often needs to be added in order to achieve an acceptable degree of balance. Moreover, the use of larger diameter wheels in combination with lower profile tires will cause the wheel to be a greater proportion of the total weight of the assembly and therefore, the wheel may be the source of a greater proportion of the total imbalance. The popularity of chrome on wheels further compounds the problem as the chroming process may add significant imbalances to a wheel.

There are over 200 million autos and light trucks on the nation's roadways. More than sixteen million new autos are produced annually in the United States. Balancing weights in the past often used lead as the weight material. An average of 4.5 ounces of lead is clipped to the wheel rims of every automobile in the United States. One estimate suggests that 13 percent of tire weights fall off at some point during the lifetime of the tire. Approximately 70,000 tons of lead are used annually to produce tire weights worldwide.

However, environmental concerns with lead and recent regulations have led to the use of alternate materials. A European Union directive prohibits the use of lead tire weights after Jul. 1, 2005.

Lead is a highly toxic chemical that has been designated as one of many priority chemicals targeted for reduction by EPA. Lead is a documented contaminant of air, land, water, plants and animals, and exposure to lead can cause serious health problems. Lead tire weights often come loose and fall off. They can end up in waterways, or in municipal landfills. When placed in acidic conditions, such as those found in municipal landfills, the lead is solubolized and can contaminate ground water.

During application, the lead weight is clipped to the wheel rim. Sometimes several weights are necessary. However, lead weights can work loose from the rim and can lead to unsightly corrosion of alloy wheels.

The need to attach balancing weight during the tire balancing operation is somewhat problematic. The weights are typically made of lead which is removed and discarded with each balancing operation.

It is standard practice to reduce adverse vibrational effects by balancing the wheel rim and tire assembly by using a balance machine and clip-on lead weights or lead tape weights. The lead balance weights are placed on the rim flange of the wheel and clamped in place in a proper position, or adhered to the wheel in the case of tape weights, as directed by the balancing machine. In general terms, balance is the uniform distribution of mass about an axis of rotation, where the center of gravity is in the same location as the center of rotation. A balanced tire/wheel assembly is one where mass of the tire/wheel assembly mounted on the vehicle's axle is uniformly distributed around the axle.

While lead weight balancing has been generally effective, there are several problems associated with their use. Primarily, the standard wheel weights are manufactured from a lead material that has been identified as having a hazardous influence on the environment. Various national and multi-national regulating agencies have passed rules restricting the use of lead balance weights in the future.

Existing balancing weights for wheels can include a weight made of a castible material, such as steel, or metal, and oftentimes include a clip which is used to secure the weight onto the wheel. A problem with clip-on weights is that they are difficult to attach to many newer wheel types which have reduced flanges. The clips also are not aesthetically pleasing on flanges of alloy wheels on some expensive automobiles.

Balance weights that are not properly secured by a clip may fall off during use—resulting in an unbalanced tire. A further disadvantage is that the standard clip on balance weight is difficult to attach to many of the newer wheels which have a reduced wheel flange and are too aesthetically unpleasing to be used on the flanges of fancy alloy wheels. In addition, once the balance weight is in position, regardless of whether a clip-on or tape weight, it is difficult to adjust to slight to moderate changes in the proper balance location caused by changing tire/wheel assembly operational characteristics, i.e., tire wear, different speeds, changes in loads which change the loaded radius of the tire, etc.

Thus, it is desirable to develop a new and improved balancing weight member fabricated from material other than lead and does not use a clip for securing the weight and which overcomes the above-mentioned deficiencies and produces advantageous results.

### SUMMARY OF THE INVENTION

The present invention relates to balance weights. More particularly, it relates to balance weights which use materials other than lead and do not use clips to secure them to a tire and wheel assembly. In accordance with one aspect of the invention, a balance weight has a body with first and second sides and has a cavity formed therein; a solid weight member substantially filling the cavity of the body; and an adhesive formed on a side of the body for securing the balance weight to an associated object to be balanced.

In accordance with another aspect of the invention, a balance weight and wheel assembly includes a tire and wheel assembly and a balance weight secured to the tire and weight assembly. The balance weight has a solid body formed entirely of plastic material, wherein the body is secured to the tire and wheel assembly via an adhesive layer on one side of the body. The body comprises an internal cavity formed within the body. The cavity has a solid weight member which substantially fills the internal cavity.

In accordance with another aspect of the invention, a method of using a balance weight or wheel assembly includes the steps of removing any existing balance weight from a wheel, measuring the inside diameter of the wheel at a location where the weight is to be placed; balancing the wheel to determine the weight at location of the balance weight; cutting a length of balance weight material to the appropriate length and weight; cleaning the area on the wheel where the weight will be secured using an appropriate solvent; removing adhesive backing from the balance weight; centering the weight at the location on the wheel where the weight is to be installed; applying firm pressure to the weight to secure the weight to the surface of the wheel; and verifying the wheel is balanced using balancing equipment.

One aspect of the present invention is the provision of a balance weight made entirely of plastic material.

Another aspect of the present invention is the provision of a balance weight which has an internal cavity substantially filled with metal material.

Yet another aspect of the invention is the provision of a balance weight which is adhesively secured to a wheel and tire assembly.

Still another aspect of the present invention is the provision of a balance weight which does not include lead or clips to secure the balance weight to a wheel and tire assembly.

Still another aspect of the invention is the provision of a balance weight which can be measured and cut to any desired length and weight.

Still other aspects of the invention will become apparent upon a reading of the following detailed description of the preferred embodiments.

### BRIEF DESCRIPTION OF THE DRAWINGS

Further aspects of the invention will become apparent by reference to the detailed description when considered in conjunction with the figures, wherein like reference numbers indicate like elements through the several views, and wherein:

FIG. 1 is a perspective view of a balance weight attached to a tube well of a tire/wheel;

FIG. 2 is a front elevational view of a balance weight in accordance with one embodiment of the present invention;

FIG. 3 is a front elevational view of a balance weight in accordance with another embodiment of the present invention;

FIG. 4 is a perspective view of a balance strip installed on a tire wheel in accordance with the invention;

FIG. 5 is a perspective view illustrating cutting the strip to a proper length;

FIG. 6 is a perspective view of a balance weight with preprinted markings which serve as guides, in accordance with another aspect of the invention;

FIG. 7 is a side elevational view of the weight of FIG. 6;

FIG. 8 is a perspective view of a double-strip weight attached to a wheel; and

FIG. 9 is a chart illustrating the number of weight segments needed during application.

### DETAILED DESCRIPTION OF THE EMBODIMENTS

The invention relates to balance weights. More particularly, the invention relates to a balancing weight to be attached to a rim of a tire. However, the balance weight can be used in other applications as well which require balancing to be performed.

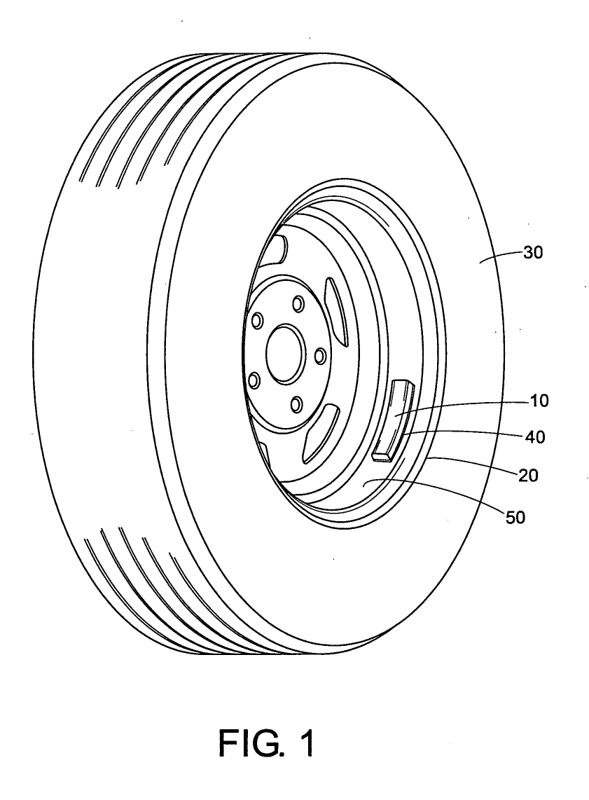

Referring to FIG. 1, a balance weight 10 is shown attached to a wheel 20 of a tire/wheel assembly 30 by an adhesive 40 attached to one of two sides of the weight. The weight is shown attached to a tube well 50, although the weight may be positioned in other locations on the tire as well without departing from the scope of the invention. The trend toward more aesthetic aluminum alloy wheels makes it important that the weight is not visible. The weight 10 may be attached to the tube well 50 using an adhesive 40 similar to that used by tape weights.

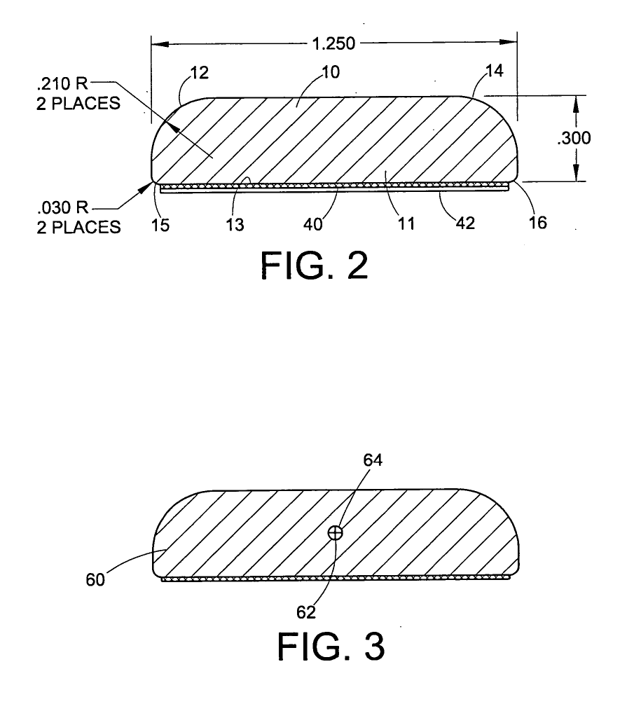

Referring now to FIG. 2, in accordance with an embodiment of the present invention, the weight 10 has a body 11 which can be fabricated or molded entirely from a plastic material, such as an extruded thermoplastic material. The weight can be manufactured to alternative dimensions and lengths. By being fabricated entirely from plastic, the weight can be easily and inexpensively manufactured and be fairly lightweight but of sufficient weight to effectively balance a tire assembly or other assembly.

The weight 10 can be made from any suitable material such as a molded or extruded rubber or thermal plastic material that will not react with the metallic surface of a wheel; however, the weight 10 is not intended to be limited to such materials, and any suitable material is also contemplated. The weight body can also be fabricated from a mixture of materials, including about 10 percent of polyvinyl chloride. The weight can be fabricated from a polyvinyl chloride (PVC) compound such as provided by Spartech Polycon of Kearny, N.J. The typical physical properties of an injection molded PVC compound would include a specific gravity of 3.02, a Duro A. hardness of 87, a tensile strength of 335 psi, an elongation percentage of 187, and a modulus at 100 percent elongation of 236 psi. The remaining parts of the mixture can include a variety of metals, in powder or solid form, and clay. Since this weight is heavier than a weight of substantially plastic, it can be up to one-third the size of an entirely plastic weight.

The weight 10 may be formed in a rigid longitudinally arcuate section of an angle θ equivalent to an angle of 180 degrees or less, or it may be formed in a flexible straight section and positioned into an arcuate section of 180 degrees or less when attached to a wheel.

It is contemplated that any suitable cross-sectional shape may be used for the weight body 11. For example, the body may be “D” shaped, oval, square or rectangular. It is also contemplated that the physical exterior dimension or height of the weight does not interfere with other systems positioned near the tire/wheel assembly such as the braking system, etc.

While the balance weight 10 is typically used on the wheel of an assembled tire and wheel, the balance weight can also be used prior to assembly of the tire and wheel. In this method the tire and wheel are individually balanced typically using a bubble balancer and the two are balance matched for minimizing imbalance. The balance weight is then attached to the wheel or the tire. This method is particularly useful when attaching the balance weight to the inner liner of the tire or the pressure side of the wheel tube well.

A first embodiment of the balance weight 10 is shown in FIG. 2. The weight shown has a height of about 0.300 inches, and a width of about 1.250 inches. A radius of about 0.210 inches is formed on upper edges 12, 14 and a 0.030 inch radius is formed on lower edges 15, 16. The weight is formed as a solid piece of plastic material and can be up to 6 inches long or longer. A weight of this size would weigh about 1.75 ounces. The plastic balance weight can be fabricated more quickly and less expensively than metal weights or weights having flowable material therein. The weights can be used with specialty type vehicles and be mass produced for low expense and easy fabrication.

An adhesive material, such as tape or film 40, is applied over a substantial portion of a bottom wall 13 of the weight body 11. The adhesive is then applied directly to the tube well or surface of the wheel to secure the weight to the wheel. A peelable layer 42 covers the adhesive layer 40 and is peeled off and removed to expose the adhesive layer.

Referring now to FIG. 3, another embodiment of a balancing weight 60 is shown having a solid extruded plastic body 62 and an internal cavity 64 centrally positioned therein having a solid and single piece of metal 66, such as steel, which fills the cavity. The cavity is shown to be round, but can be of different shapes such as oval or rectangular, without departing from the scope of the present invention. Also, the cavity is shown to be centrally positioned within the weight, but can also be offset if needed for balancing. The metal piece allows additional weight to the balancing weight without the additional expense of fabricating the entire weight from metal. The metal piece 66 substantially fills the entire cavity 64 and is of a different density than the plastic body 62. The metal piece 66 is fixed relative to the plastic body 62 and does not move relative thereto.

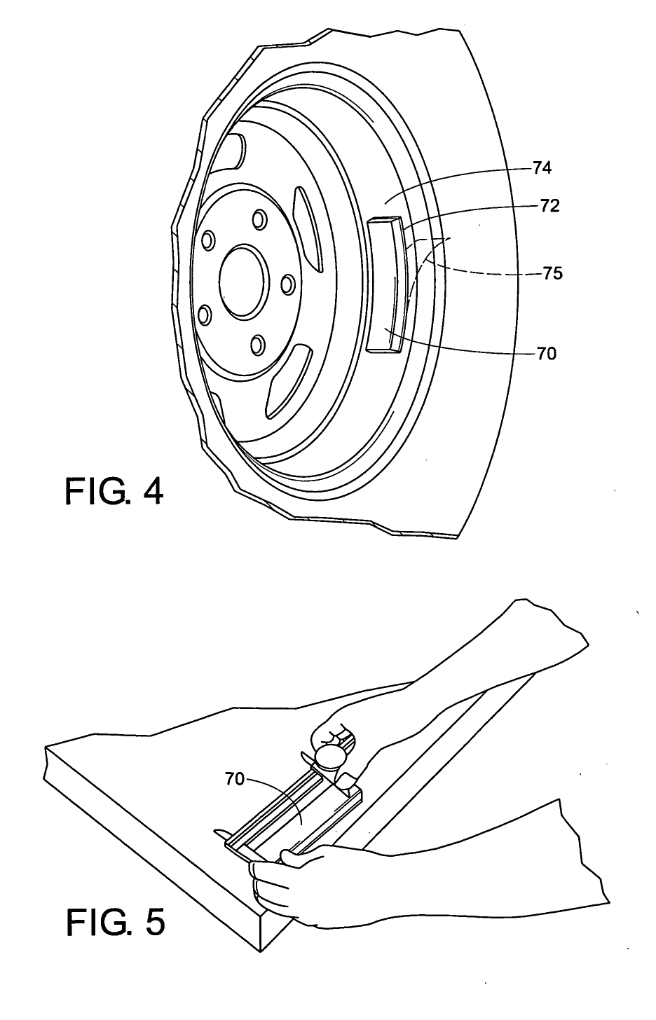

Referring now to FIG. 4, the plastic balance weight is used in a balance system which includes an extruded plastic weight strip 70 with an adhesive backing layer 72. An additional layer 75, formed of thin plastic, covers the adhesive backing and is removed or peeled off of the weight when the weight is applied to a wheel. Referring to FIG. 4, the strip 70 is applied to the inside of a wheel 74 instead of clipping a lead weight to the rim. Referring to FIG. 5, the strip 70 can be measured and easily cut to any length to achieve an accurate balance.

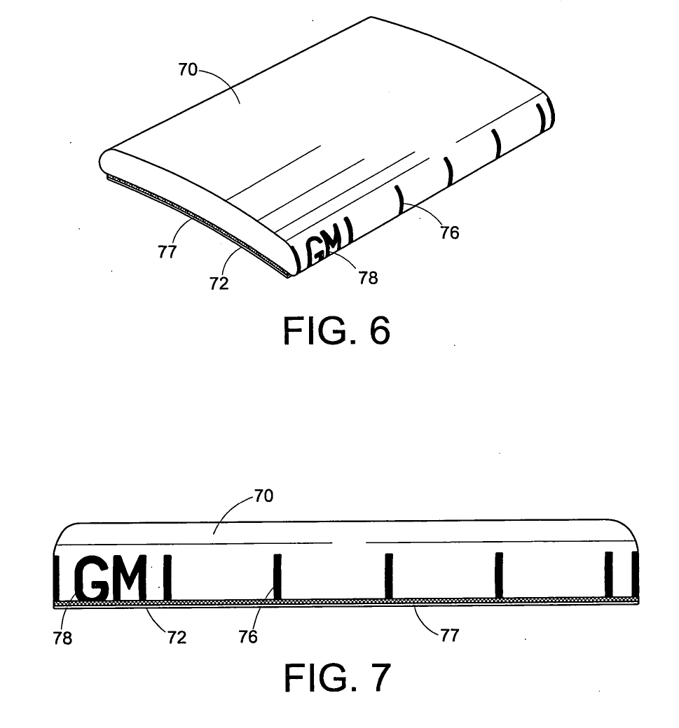

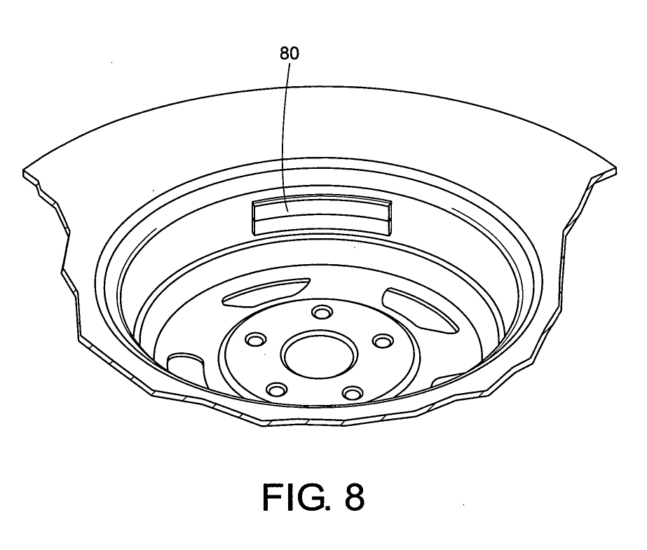

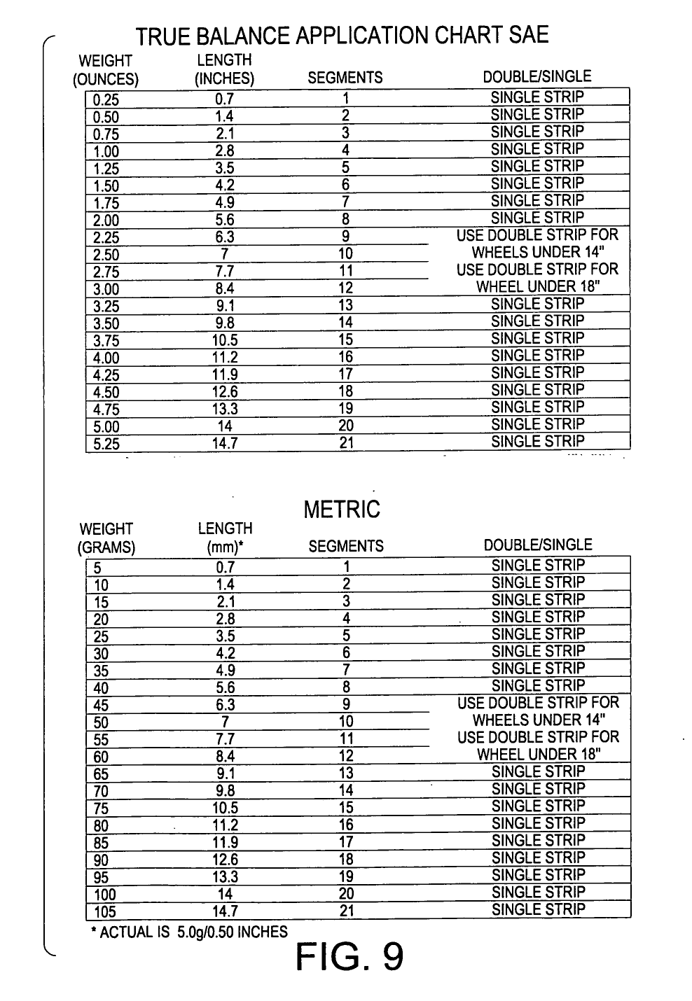

Referring to FIGS. 6 and 7, preprinted markings or lines 76 on the weight body can serve as guides for determining the length and weight of the weight to be used. Notches can also be used to enable the weight to be cut to the proper size. A marking 78, such as “GM”, or “gram”, or “oz” or “ounces” is used to determine the number of grams or ounces of the size of the weight. For example, if a 15 gram weight size is required, the weight would be cut at the third marking 77. Each “GM” marking denotes 5 grams. Marking is done on about every 0.7 inches for 0.25 oz. weights, or every 0.5 inches for 5 g weights. As seen in FIG. 8, a double-strip 80 can be used if more weight is required for a larger wheel.

The balance weight can be used in one of two applications. First, the weight can be used in a static application. A static application involves the use of a single weight placed near the center of the interior of the wheel rim. This application generally involves correction of a particular area of the tire that is worn and is affecting the balance of the tire.

Second, the balance weight can be used in a dynamic application. This involves the placement of two weights on the tire, one near the edge of the rim and one near the center of the interior of the rim. Existing weight systems include the use of a clip to secure the weight to the edge of the rim. In the embodiment of the present invention, each of the weights is adhesively secured to the edge and the interior of the rim.

Balancing machines can be used to determine placement of the weight such as by direct measure or 360 degree weight placement displaying which makes positioning of the weight easy and accurate. The balance weights are subjected to testing on actual in-service vehicles during demanding summer weather. Weight strips typically travel a total of over 60,000 miles with no failures in the adhesive or weight-related loss of balance. The prior art lead balance weights are fixed in position by an operator as directed by the spin balance machine. Lead balance weights are attached to the wheel slightly off position by the operator. This requires the operator to rebalance. Additionally, once the tire/wheel assembly is in operation on the vehicle, tire wear, pot holes, etc. will cause the tire/wheel assembly to go out of balance.

The steps for installing and using the balance weights of the present invention are as follows. First, any existing weights are completely removed from the tire/wheel assembly. Second, the inside diameter of the wheel is measured at the location(s) where weights will be placed. Third, using available balance equipment, which are well known in the industry and will not be discussed herein, and associated operating instructions, the total weight (in 0.25 oz. or 5 g increments) and appropriate location required to balance are determined. Fourth, the chart in FIG. 9 is referred to for the number of segments required. For example, if a weight of 0.50 ounces is required, a length of 1.4 inches (or two segments) is cut from the weight so that two segments of the weight are part of the cut material. If a weight of 15 grams is needed, a length of 38 mm (or three segments) is cut. Fifth, a length of balance material is cut with the required number of segments. Sixth, for double-strip application, the length of material is cut in half. Seventh, using an appropriate solvent, an area is cleaned of the inside of the wheel 1 inch (3 cm) larger on each end than installed length of the strip(s) to be applied. Eighth, the adhesive backing from the strip(s) of balance material is removed, the weight(s) are centered at the balancing point, and firm pressure is applied all along the strip(s) to secure the strips to the wheel. For double-strip application, the strips must be side-by-side. Ninth, the balance is verified with the balance equipment. Tenth, if additional weight is indicated, an appropriate single or double strip of weight is added as indicated by the balancing equipment and according to the directions above. Eleventh, the wheel may be remounted and the vehicle can be driven immediately.

The exemplary embodiments have been described with reference to the preferred embodiments. Obviously, modifications and alterations will occur to others upon reading and understanding the preceding detailed description. For example, the balance weights can be used in other environments other than vehicles, such as planes, machinery, etc. It is intended that the exemplary embodiment be construed as including all such modifications and alterations.

1. A balance weight comprising:
a body having an internal cavity formed therein; said body having a first side and a second side;
a solid weight member substantially filling said cavity of said body; and
an adhesive formed on one of said first side and said second side of said body for securing said balance weight to an associated object to be balanced.

2. The balance weight of claim 1, wherein said balance weight body is longitudinally arcuate about an angle of 180 degrees or less.

3. The balance weight of claim 1, wherein said solid weight member occupies the entire volume of the interior cavity.

4. The balance weight of claim 1, wherein the balance weight is manufactured of a polymeric material.

5. The balance weight of claim 1, wherein said balance weight is manufactured as an extrusion, molded or fabricated.

6. The balance weight of claim 1, wherein said balance weight has a cross-sectional geometry in the form generally of a “D”, an oval, square, or a rectangle.

7. The balance weight of claim 1, wherein said body is formed of extruded thermoplastic material.

8. The balance weight of claim 1, wherein said body is injected molded from a mixture comprising at least 10 percent of polyvinyl chloride.

9. The balance weight of claim 1, wherein said weight member is formed of metal.

10. The balance weight of claim 1, wherein said weight member is fixed relative to said body.

11. The balance weight of claim 1, wherein said weight member has a density different from the density of said body.

12. A balance weight and wheel assembly, comprising:
a tire and wheel assembly;
a balance weight secured to said tire and weight assembly comprising:
a solid body formed entirely of plastic material, wherein said body is secured to said tire and wheel assembly via an adhesive layer on one side of said body.

13. The balance weight and wheel assembly of claim 12, wherein said body comprises an internal cavity formed within said body.

14. The balance weight and wheel assembly of claim 13, wherein said cavity comprising a weight member which substantially fills said internal cavity.

15. The balance weight and wheel assembly of claim 14, wherein said weight member comprises metal material.

16. The balance weight and wheel assembly of claim 14, wherein said weight member comprises a single piece of metal material.

17. The balance weight and wheel assembly of claim 12, wherein said balance weight body is longitudinally arcuate about an angle of 180 degrees or less.

18. The balance weight and wheel assembly of claim 12, wherein said solid weight member occupies the entire volume of the interior chamber.

19. The balance weight and wheel assembly of claim 12, wherein the body is manufactured of a polymeric material.

20. The balance weight and wheel assembly of claim 12, wherein said body is manufactured as an extrusion, molded or fabricated.

21. The balance weight and wheel assembly of claim 12, wherein said body has a cross-sectional geometry in the form generally of a “D”, an oval, square, or a rectangle.

22. The balance weight and wheel assembly of claim 12, wherein said body is formed of extruded thermoplastic material.

23. The balance weight and wheel assembly of claim 12, wherein said body is injected molded from a mixture comprising at least 10 percent of polyvinyl chloride.

24. The balance weight and wheel assembly of claim 12, wherein said weight member is formed of steel.

25. The balance weight and wheel assembly of claim 12, wherein said body has a height of about 0.3 inches.

26. The balance weight and wheel assembly of claim 12, wherein said body has a width of about 1.25 inches.

27. The balance weight and wheel assembly of claim 12 wherein said body weighs about 1.75 ounces.

28. The balance weight and wheel assembly of claim 12, wherein said body comprises a plurality of markings or notches for indicating the weight of the body.

29. A method of using a balance weight or wheel assembly, comprising the steps of:
removing any existing balance weight from a wheel,
measuring the inside diameter of the wheel at a location where the weight is to be placed;
balancing the wheel to determine the weight at location of the balance weight;
cutting a length of balance weight material to the appropriate length and weight;
cleaning the area on the wheel where the weight will be secured using an appropriate solvent;
removing adhesive backing from the balance weight;
centering the weight at the location on the wheel where the weight is to be installed;
applying firm pressure to the weight to secure the weight to the surface of the wheel; and
verifying that the wheel is balanced using balancing equipment.

30. The method of claim 29, further comprising the step of:
referring to an application chart for the number of weight separate to be cut based on the weight and length of weight required.

31. The method of claim 30, further comprising the step of:
cutting the balance length of the weight in half if a double strip application is required.

32. The method of claim 31, further comprising the steps of:
applying weight strips side by side for a double strip application.

33. The method of claim 29, further comprising the step of: providing a balance weight formed of plastic with a metal weight member formed within an internal cavity thereof.
